(19) United States
(12) Patent Application Publication
(10) Pub. No.: US 2012/0278459 A1
(43) Pub. Date: Nov. 1, 2012

(54) THROTTLING BURSTY CPU UTILIZATION DUE TO BURSTY TCP FLOWS

(75) Inventors: William Carroll VerSteeg, Buford, GA (US); William E. Wall, Atlanta, GA (US)

(73) Assignee: CISCO TECHNOLOGY, INC., San Jose, CA (US)

(21) Appl. No.: 13/094,456

(22) Filed: Apr. 26, 2011

(51) Int. Cl. G06F 15/173

(52) U.S. Cl. 709/223

(57) ABSTRACT

The rate of incoming data is adjusted based on processor utilization. A threshold of processor usage at which incoming data can be stopped by deferring TCP window updates can be specified. A threshold at which incoming data can be resumed by opening the TCP window can be specified. The threshold can be determined by the operating system or by a rate-adaptive video rendering application.

### BACKGROUND

TCP (Transmission Control Protocol) is a rate-adaptive protocol; that is, the rate of data transfer adapts to the prevailing load conditions within the network. The rate of data transfer also adapts to the processing capacity of the receiver. Typically, there is no predetermined TCP data transfer rate. If the network and the receiver have additional capacity, (signaled by the sender receiving timely acknowledgments from the receiver) a TCP sender will send more data in its next transmission. A TCP sender will reduce its sending rate when consistent data loss (e.g., lost packets) is detected. Data loss can be indicated by timeouts. A timeout occurs when an acknowledgment is not received in a round trip time period (RTT) calculated by the sender. Data loss can also be signaled by receiving duplicate acknowledgements.

When a rate adaptive data flow, such as streaming video data, starts up on a host, the video data can fill the TCP window on the receiver relatively quickly. While the data is filling the TCP window buffer, the speed of data transmission can be substantially higher than the ordinary data rate. If the rate of data transmission gets too high, the central processing unit (CPU) of the receiving device can become over-utilized by the TCP layers, leading to starvation of the other applications running on the host. For example, if a video rendering application does not get enough CPU time because the CPU is busy receiving streaming video data, the video rendering application can have insufficient CPU time to decode the data in the buffer and can fall behind in the decoding process. If the video rendering application falls behind, the application may down-shift to a lower resolution video data stream.

The existing TCP windowing mechanism can fill the TCP window as fast as the network load permits. The effect in a high bandwidth, low latency environment can be bursty data flow. For example, each 1 second chunk of data may be received in the first 100milliseconds of the data flow, the channel becoming idle for the remaining 1.9 seconds. Thus, typically the CPU utilization on the host will be very high during the first 100 milliseconds, and fairly idle for the remaining 1.9 seconds. The result can be a degraded user experience as the video decode process is jumpy. When the video decode process becomes jumpy, the application code may mistakenly interpret the cause as insufficient CPU resources or congestion driven loss and shift to a lower stream.

### SUMMARY

The rate of incoming TCP traffic is adjusted based on processor utilization to reserve enough processing time for rate adaptive video applications to render the video, thus avoiding jumpy playout and/or frequent shifts between high and low resolution. A CPU usage threshold can be used to limit the rate of incoming data proactively to avoid a degraded user experience. A CPU usage threshold may be chosen that allows a data rendering application such as a video rendering application enough CPU time to process the incoming data. Detecting CPU usage that exceeds a specifiable threshold can result in closing the TCP window. Upon detection of the CPU usage falling below a specifiable usage, the TCP window can be re-opened. By opening and closing the TCP receive window based on CPU usage, the burst rate of the TCP sessions can be limited. Thus, when excessive CPU usage is detected, a TCP receive policy may be altered to allow other applications on the host that may be CPU-starved to execute properly. Thus incoming bandwidth can be adjusted based on a CPU threshold.

### BRIEF DESCRIPTION OF THE DRAWINGS

FIG. 1 is a block diagram illustrating an example of a digital network 100 in accordance with aspects of the subject matter disclosed herein;

FIG. 2 is a block diagram of an example of a system that adjusts incoming data flow based on processor utilization in accordance with aspects of the subject matter disclosed herein;

FIG. 3 is a flow diagram of an example of a method of adjusting incoming data flow based on processor utilization in accordance with aspects of the subject matter disclosed herein;

FIG. 4 is a flow diagram of an example of a method to set a CPU utilization threshold in accordance with aspects of the subject matter disclosed herein;

FIG. 5 is a flow diagram of an example of a method to control the flow of incoming data in accordance with aspects of the subject matter disclosed herein; and

FIG. 6 is a block diagram of a computing device in accordance with aspects of the subject matter disclosed herein.

### DETAILED DESCRIPTION

### Overview

Most applications rely on the TCP windowing mechanism to rate limit TCP data flow. If the buffer allocated to a TCP window is not completely full when data is received, the TCP protocol increases the size of the TCP window to fill the buffer. When the buffer is full, the TCP window is set to zero (i.e., is closed). The data rendering application reads the buffer, and processes it, thereby emptying the buffer. When the buffer is empty, the TCP layer reopens the window to allow more data to come in.

The amount of space allocated for the TCP Receive Window (RWIN) determines the amount of data that a host can accept without acknowledging the sender. In each TCP segment, the receiver specifies in the TCP receive window field the amount of additional received data (in bytes) that it is willing to buffer for the connection. At any particular time, the RWIN advertised by the host at the receive side corresponds to the amount of free receive memory it has allocated for a particular connection with a sender. Failure to allocate enough memory may result in the receiver dropping received packets because there is not enough space to hold the incoming data. Failure to use all of the buffer space acts to increase the rate of data flow.

The sender can send only up to the amount of data determined by the size of RWIN. Before the sender sends more data, the sender waits for an acknowledgment and window size update from the receiver. If the sender does not receive acknowledgement for a packet it sends, the sender will stop sending data and may set a timer. If the timer expires and the sender still has not received an acknowledgment from the receiver (a timeout occurs), the sender may try to retransmit the data (to correct data loss) or may send a small packet to trigger an acknowledgment from the receiver. Retransmission is a costly event and one to be avoided when possible.

Even if there is no packet loss in the network, windowing can limit throughput. Because TCP transmits data up to the window size before waiting for the acknowledgements, the full bandwidth of the network may not be used or may be used inefficiently (i.e., use can be bursty). The limitation caused by window size may be determined as:

Throughput=RWIN/RTT;

where RWIN is the TCP receive window size and RTT is the round-trip time for the path.

In many rate adaptive protocols a video rendering application will reduce resolution of the video if the CPU gets too busy to support a higher resolution. This can result in a distracting and undesirable user experience in which the video bounces between higher and lower resolution, resulting in a visibly jerky video. In accordance with aspects of the subject matter disclosed herein, A CPU usage threshold is used to limit the instantaneous rate of incoming data proactively to avoid a degraded user experience. A CPU usage threshold may be chosen that allows a data rendering application such as a video rendering application enough CPU time to process the incoming data. In accordance with aspects of the subject matter disclosed herein, detecting CPU usage that exceeds a specifiable threshold results in closing the TCP window. Upon detection of the CPU usage falling below a specifiable usage, the TCP window can be re-opened. By opening and closing the TCP receive window based on CPU usage, the burst rate of the TCP sessions can be limited. Thus, when excessive CPU usage is detected, a TCP receive policy may be altered to allow other applications on the host that may be CPU-starved to execute properly. Thus instantaneous incoming bandwidth can be adjusted based on a CPU threshold. The CPU threshold can be adjusted to limit incoming bandwidth. CPU usage threshold can be coordinated between the application and the operating system using a new parameter to the getsockopt( )function. These operations can be implemented on the devices of customer premises equipment (CPE) described below.

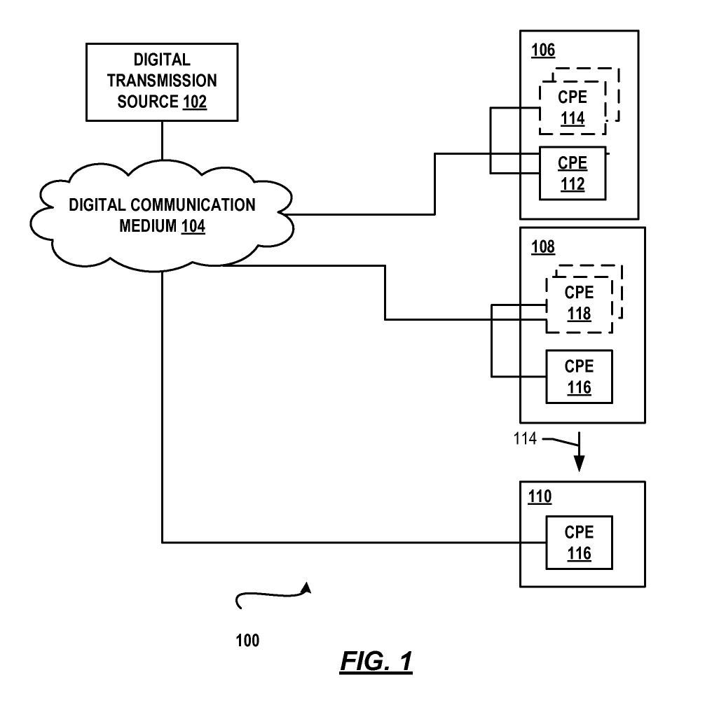

FIG. 1 illustrates an example digital network 100. A digital transmission source 102 can send a signal over a digital communication medium 104 to one or more premises such as premises 106, 108, and 110. The premises 106, 108, 110 can be dwellings, business offices, other types of buildings, and/or other physical property.

The one or more premises such as premise 106, 108 and 110 can include customer premises equipment (CPE) such as 112, and 116 and can include additional CPE such as CPE 114 and 118. The CPE 112 can, for example, be physically located on the premises 106. The digital transmission source 102 may be a cable television headend that sends a digital signal including a plurality of television channels over a digital cable network. In some implementations, the cable network also carries broadband Internet signals. The cable network can include coaxial cables, and/or fiber optic cables. The cable network can include branches that service premises such as premises 106, 108, and 110.

CPE devices for the cable network can include, for example, set top boxes (STB), digital video recorders (DVRs), digital terminal adapters (DTAs), and cable modems (for broadband Internet access). In general, a DTA is a device used to provide basic cable service to analog television tuners on cable networks that no longer transmit analog cable signals (or transitioning networks that plan to soon phase analog channels out).

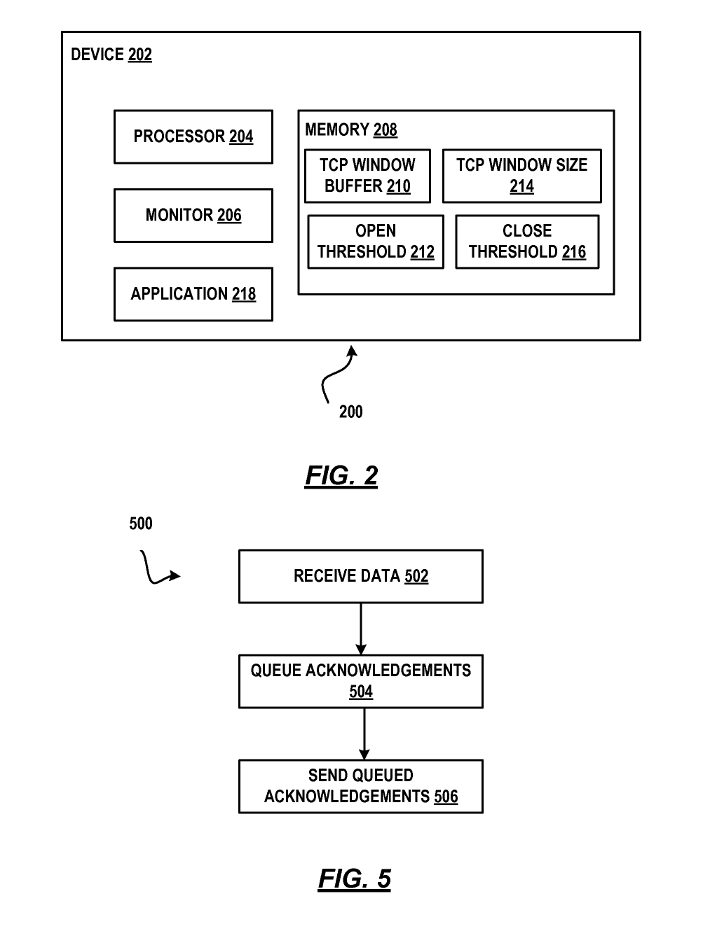

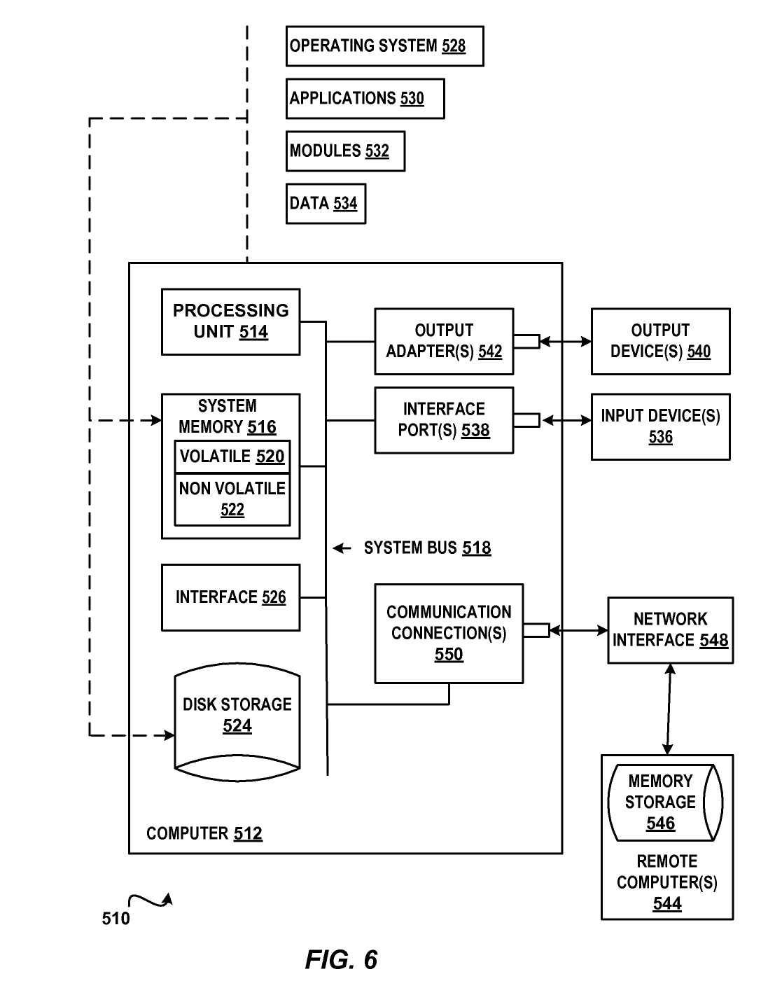

FIG. 2 illustrates an example of a system 200 device that limits bursty data flow based on CPU utilization. System 200 can be a CPE as described with respect to FIG. 1, and may be a device that performs video rendering. System 200 can be a portion of a CPE. System 200 can include one or more devices such as device 202. Device 202 can be a computer as described below with respect to FIG. 6. Device 202 can include one or more of: a processor such as processor 204, a memory such as memory 208, a processor monitor such as processor monitor 206, a TCP window buffer such as TCP window buffer 210, a TCP window size indicator such as TCP window size indicator 214, a TCP open window processor utilization threshold 212 and a TCP close window processor utilization threshold 216. System 200 may also include one or more applications such as application 218. Application 218 may be a video rendering application.

Data can be received from a sender (an external source), not shown, over a network, as is known in the art. As described above, when data comes in and starts to fill the TCP window buffer, traditional TCP processing will increase the value stored in a TCP window size variable if the data received does not entirely fill the allocated TCP window buffer. The TCP window size value is returned to the sender with each acknowledgement (ack) sent back to the sender. Repeatedly sending increased TCP window size values can result in an increased rate of data flow and an accompanying increase in the amount of utilization of the processor that is devoted to receiving data from the sender. Hence an application running on the same processor may receive relatively less processing time. In fact the application may not receive enough processor time to decode the data stored in the TCP window buffer. When the application decodes the data stored in the TCP window buffer, the decoded data is removed from the TCP window buffer. Thus, the process of decoding the data received into the TCP window buffer acts to drain or remove data from the TCP window buffer allowing the TCP window buffer to be able to receive more data from the sender. As the TCP window buffer becomes full and is not drained quickly enough, the value of the TCP window size can be set to zero, stopping the flow of data. A bursty TCP data flow can result, meaning flow rates can vary widely between a high rate of data flow and no data flow.

Meanwhile, because the application is not receiving enough processing time on the processor, the application may reduce the resolution rate of the video being played. As the TCP window buffer becomes full and is not drained, the rate of data flow into the buffer can fall, decreasing the processor utilization for receiving incoming data and increasing the amount of processor power available for the application. The application may decrease the video resolution in response to receiving little processing time and may increase the resolution of the video. As the amount of processor utilization cycles between:
high utilization of the processor for processing incoming data because the TCP window buffer is not being used and corresponding low utilization of the processor for video rendering and
low utilization of the processor for processing incoming data because the TCP window buffer is not being drained quickly enough and corresponding higher amount of processing time provided to the application for video rendering,
   an erratic switching between low and high resolution video rendering can occur.

In accordance with aspects of the subject matter disclosed herein, an application such as application 218 can signal an operating system (not shown) to implement a processor usage threshold. The processor threshold usage threshold can be a threshold of processor utilization at which a TCP window is allowed to close. The application 218 may pass the operating system the value for the processor usage threshold at which the TCP window is allowed to close. In FIG. 2 the value for the processor usage threshold can be close window processor usage threshold 216. Similarly, a second threshold such as open TCP window processor usage threshold 212 may include a value for a processor usage threshold at which a TCP window is opened. For example, a particular application such as a video rendering application may set a processor utilization threshold for closing the TCP window to 80%. When the processor utilization monitor 206 detects that processor utilization of processor 204 reaches 80%, the TCP window can be closed by deferring the TCP window updates. Similarly the application may set a processor utilization threshold for opening the TCP window to 70%. When the processor utilization monitor detects that processor utilization of processor has fallen to 70%, the TCP window can be opened by sending the window updates that were previously deferred, the window value comprising a size of the TCP window buffer 210 for the connection to the sender.

In accordance with some aspects of the subject matter described herein, instead of the application initiating a request to implement the processor usage threshold, the operating system may by default limit usage of the processor. The function setsockopt( ) can be used to set a threshold and the function getsockopt( )can be used to retrieve the value of the threshold. Both an open TCP window threshold and a close TCP window threshold can be established and examined.

In some implementations, the host TCP stack can have a state variable assigned to each session that specifies the maximum processor load that is allowed and still send window updates. The maximum processor load can be the percentage of processor capacity that the current session is allowed to use, the total processor load for the TCP/IP layer or the total processor load for all processes executing on the device. The state variable in accordance with some aspects of the subject matter described herein can be examined before each window update is sent by the receiver. The maximum rate at which a particular processor can receive data can be generated at system build time or can be derived using machine-learning techniques.

In some implementations, an algorithm calculating maximum processor usage may be executed on related CPE equipment (e.g., a cable modem, DSL modem or other home gateway device) on behalf of a naive host. Such middleboxes may also employ window deferral techniques to smooth out bursty TCP sessions without calculating CPU usage rates. Such an implementation is similar to ack concatenation strategies, but may include manipulation of the windowing strategy to slow down the flow.

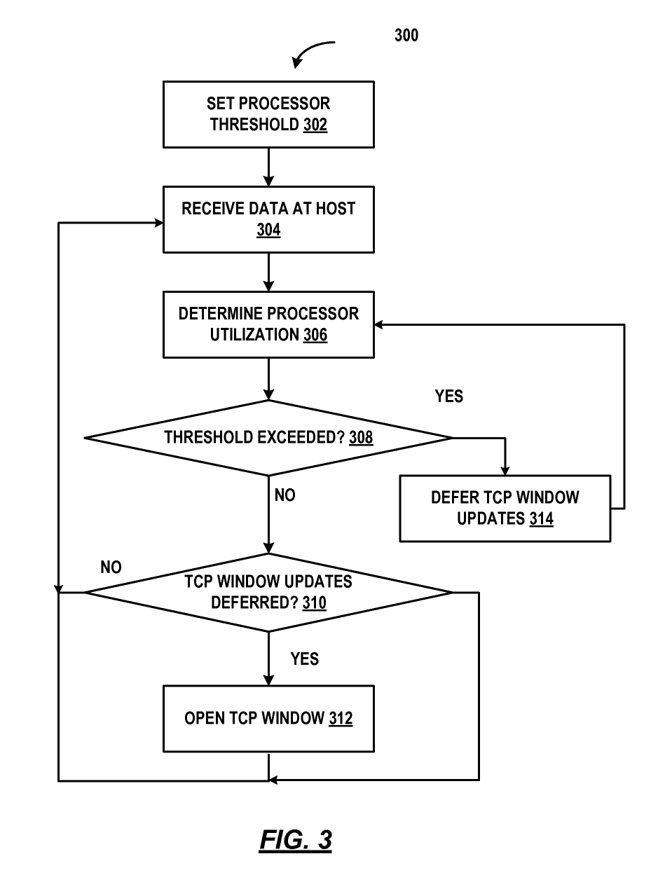

Referring now to FIG. 3, there is illustrated an example flow diagram 300 of processes performed to control the flow of incoming data based on processor utilization. At 302, a processor utilization threshold can be set. The processor utilization threshold may be set based on a percentage of the CPU that a session may use, a total CPU load of the TCP/IP layer, or a total CPU load. At 304, data can be received at the host. The host may be any CPE device, for example, set top boxes (STB), digital video recorders (DVRs), digital terminal adapters (DTAs), and cable modems (for broadband Internet access). The data may be TCP/IP data, such as video data. At 306, the processor utilization can be determined, and at 308 it can be determined if the processor utilization exceeds the threshold set at 302. For example, receiving bursty video data may create a situation where the TCP/IP layer consumes a large percentage of the processor's processing capability.

At 308, the processor utilization is compared with the processor utilization threshold. If the processor utilization is below the threshold or alternatively, does not exceed the threshold, processing can continue at 310. At 310 the system determines if previous window updates have been deferred. If the TCP window updates have been deferred, the TCP window can be reopened by sending the deferred window updates at 312 and processing can continue at 304. Alternatively, if the TCP window updates have been deferred, the processor utilization determined at 306 can be compared with a reopen threshold. If the processor utilization has not fallen to the level of the reopen threshold, processing can continue at 306, leaving the TCP window closed. If at 310, it is determined that the TCP receive window (RWIN) is not closed, the flow can return to 304 to receive additional data. However, if at 308 the processor utilization exceeds the threshold, the TCP window updates can be deferred. The receiver can signal to the sender that it is not ready to receive additional data by not opening the TCP window . The process may then continue at 306, where the processor utilization is again determined.

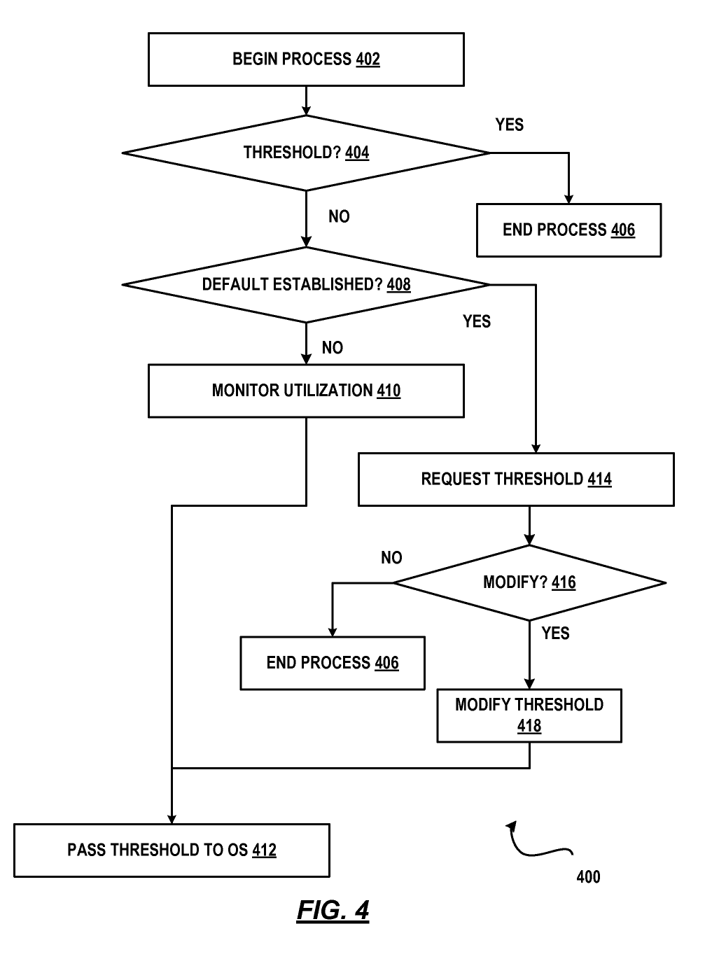

FIG. 4 illustrates an example flow diagram 400 of processes performed to set a CPU utilization threshold. At 402, the process begins. At 404, in accordance with some aspects of the subject matter described herein, it is determined if a threshold exists within the host or if the threshold is current. If a threshold exists or is current, then the process ends at 406, as no action may be necessary. However, if no threshold exists or if the threshold is to be updated, then the process may continue at 408. At 408 it can be determined if a default is established. At 410, if no default threshold has been established, processor utilization can optionally be monitored. An application running on the host (e.g., a video decoder application) may determine a threshold based on monitoring the processor usage or based on a supplied threshold and pass the threshold to the host's operating system at 412. For example the application may utilize the setsockopt( )function call to set the CPU threshold in the operating system. The threshold value may then be utilized at step 302 in the flow 300.

At 408, the host's operating system may have a CPU threshold that is set as a default. The default may be determined based on a predetermined data rate that is known to not consume excessive CPU capacity. An application may request the CPU threshold from the operating system (kernel) at 414 using, e.g., the getsockopt( )function call. The application may accept this value at 416 and end the process at 406 or may modify it at 418 and pass the modified value back to the operating system at 412. The threshold value may then be utilized at step 302 in the flow 300.

Alternatively, in another processing path, at 408, the host's operating system may not have a default threshold. At 410, the CPU utilization may be monitored over a predetermined time period time to determine an appropriate threshold based on the monitored CPU utilization and passed to the operating system at 412. The threshold value may then be utilized at step 302 in the flow 300.

FIG. 5 illustrates an example flow diagram 500 of processes performed to control the flow of incoming data. The processes of the flow may be performed at a device other than the host. The other device may be another CPE device, as the host may not support a data flow control mechanism, such as that described in FIGS. 3 and 4 above. At 502, data is received by the CPE device and the host. At 504, the TCP/IP acknowledgements and TCP window updates may be queued as part of an acknowledgement concatenation and TCP window deferral scheme. Based on the data rate, a predetermined number of acknowledgements or window updates may be queued before an acknowledgement or window update is forwarded to the sender at 506. The queuing of acknowledgements or window updates may be used to pace the rate at which data is communicated by the sender and received at the host, thus reducing the CPU load of the host.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal, that is generated to encode information for transmission to suitable receiver apparatus for execution by a computer. The computer-readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. FIG. 6 illustrates a computing device in the form of a computer 512. Computer 512 may include a processing unit 514, a system memory 516, and a system bus 518. The system memory 516 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514.

Software can act as an intermediary between users and computer resources. Software may include an operating system 528 which can be stored on disk storage 524, and which can control and allocate resources of the computer 512. Disk storage may be a hard disk drive connected to the system bus 518 through a non-removable memory interface such as interface 526. System applications 530 take advantage of the management of resources by operation system 528 through program modules 532 and program data 534 stored either in system memory 516 or on disk storage 524. Computers can be implemented with various operating systems or combinations of operating systems.

A user can enter commands or information into the computer 512 through an input device such as device 536. Input devices 536 include but are not limited to a pointing device such as a mouse, trackball, stylus, touch pad, keyboard, microphone and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node and typically includes many or all of the elements described above relative to the computer 512 although only a memory storage device 546 has been illustrated in FIG. 6. Remote computer(s) 544 can be logically connected via communication connection 550. Network interface 548 encompasses communication networks such as local area networks (LANS) and wide area networks (WANS) but may also include other networks. Communications connection(s) 550 refers to the hardware/software employed to connect the network interface 548 to the bus 518. Connection 550 may be internal to or external to computer 512 and can include internal and external technologies such as modems (telephone, cable, DSL and wireless) and ISDN adapters, Ethernet cards and so on. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, computers can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising:
a processor;
a memory;
a module that when loaded into the memory causes the processor to regulate incoming data flow based on usage of the processor by:
monitoring processor usage;
in response to the processor usage reaching a specified usage, closing a TCP window.

2. The system of claim 1, wherein the specified usage comprises a threshold value at which the TCP window is closed.

3. The system of claim 2, wherein the specified usage at which the TCP window is closed comprises a first threshold and wherein a second threshold specifies a processor usage at which the TCP window is opened in response to the processor usage falling to the second threshold.

4. The system of claim 1, wherein the specified usage is provided by an operating system.

5. The system of claim 1, wherein the specified usage is provided by an application.

6. The system of claim 5, wherein the application comprises a rate adaptive video-rendering application.

7. The system of claim 2, wherein the operating system implements the threshold value in response to a signal received from a rate adaptive video-rendering application.

8. The system of claim 2, wherein the threshold varies with different executions of the application.

9. The system of claim 1, wherein the system comprises customer premises equipment.

10. A method comprising:
specifying a first processor usage threshold and a second processor usage threshold on a processor of a computing device;
monitoring processor usage of the processor;
in response to the processor usage of the processor reaching the first specified processor usage threshold, closing a TCP window;
in response to the processor usage of the processor falling below the second processor usage threshold, opening the closed TCP window.

11. The method of claim 10, further comprising receiving the first processor usage threshold from a rate adaptive video rendering application.

12. The method of claim 10, further comprising receiving the second processor usage threshold from a rate adaptive video rendering application.

14. The method of claim 10, wherein the computing device comprises customer premises equipment.

15. The method of claim 10, wherein the first processor usage threshold and the second processor usage threshold are determined by an operating system of the computing device.

16. The method of claim 10, wherein the first processor usage threshold comprises one of:
a percentage of the processor that a particular execution of the rate adaptive video application can use,
a total processor load of a TCP/IP layer or
a total processor load for all processes executing on the computing device.

17. A computer readable storage medium specifying instructions that when executed by a processor of a computing device, causes the processor to:
specify a first processor usage threshold and a second processor usage threshold for the processor of the computing device;
monitor processor usage of the processor;
in response to the processor usage of the processor reaching the first specified processor usage threshold, closing a TCP window;
in response to the processor usage of the processor falling below the second processor usage threshold, opening the closed TCP window.

18. The computer readable storage medium of claim 17, comprising further instructions that when executed cause the processor to:
receive the first processor usage threshold and the second processor usage threshold from a rate adaptive video rendering application executing on the computing device.

19. The computer readable storage medium of claim 17, comprising further instructions that when executed cause the processor to:
receive the first processor usage threshold and the second processor usage threshold from a middlebox device attached to the computing device.

20. The computer readable storage medium of claim 17, comprising further instructions that when executed cause the processor to:
receive the first processor usage threshold and the second processor usage threshold from an operating system executing on the computing device.
